(19) United States
(12) Patent Application Publication
(10) Pub. No.: US 2024/0036605 A1
(43) Pub. Date: Feb. 1, 2024

(54) NFT Display System

(71) Applicant: Technico LLC, Sheridan, WY (US)

(72) Inventor: Nicolas Scatino, Scottsdale, AZ (US)

(73) Assignee: Technico LLC, Sheridan, WY (US)

(21) Appl. No.: 18/362,209

(22) Filed: Jul. 31, 2023

Related U.S. Application Data
(60) Provisional application No. 63/347,565, filed on Jun. 1, 2022.

(51) Int. Cl. G06F 1/16; H02J 50/10

(52) U.S. Cl. CPC G06F 1/1637; G06F 1/1635; G06F 1/163; G06F 1/1688; H02J 50/10

(57) ABSTRACT

The disclosure concerns a NFT display system which in various embodiments may be worn by the user or coupled or attached to a user's personal item. The NFT display system includes a wearable article, a display unit, and in some embodiments, an accessory which may be coupled to the display unit. The user's NFT collectible is displayed on a display screen of the display unit. The display unit is adapted with a wearable article such that it is wearable by the user. The wearable article may be a lanyard or necklace which may be worn around the user's neck. The user can configure the display screen to display the user's NFT or NFTs while the user wears the NFT display system.

### CROSS-REFERENCE TO RELATED APPLICATIONS

This application claims benefit of priority with U.S. Provisional Application Ser. No. 63/347,565, filed Jun. 1, 2022; the entire contents of which are hereby incorporated by reference.

### BACKGROUND

### Field of the Invention

This invention relates to a wearable NFT digital collectible display system; more particularly, to a NFT display system which is adapted to be worn by the user.

### Description of the Related Art

NFT collectibles, also known as NFTs or non-fungible token digital collectibles, are becoming increasingly popular. These NFT collectibles are minted on a blockchain and can come in the form of image art, music, text, and other digitizable assets. What makes NFT collectibles unique is that they have their own encrypted address on the blockchain, which can make each NFT collectible a one-of-a-kind digital asset. Part of the appeal of NFT collectibles is that NFT owners can display, share, sell, or otherwise provide some form of access to their NFT. For example, an NFT collectible may be displayed on social media platforms. NFTs are commonly stored in cryptocurrency wallets for security, and the wallets may facilitate the display, offer for sale, sales, and/or sharing of the NFT.

If a user wishes to display their NFT in a physical or “in-person” setting they may find the effort confusing or difficult because there are not adequate available options to do so. There exists in the field of digital assets and NFT collectibles a need for means of displaying, or otherwise offering some form of access to, an NFT collectible in a physical or “in-person” setting.

### SUMMARY

The disclosure concerns a NFT display system which in various embodiments may be worn by the user or coupled or attached to a user's personal item. The user's NFT collectible is displayed on a display screen which is configured to be wearable by the user. The display screen may be attached or coupled to a wearable article such that the user may wear the display screen. The wearable article may be a lanyard or necklace which may be worn around the user's neck. The user may then configure the display screen to display the user's NFT while the user wears the wearable article.

The display screen may be permanently attached to the wearable article. Alternatively, the display screen may be removably coupled to the wearable article. The display screen may have one or more additional coupling features which enable the user to couple a variety of accessories to the display screen. For example, the user may couple personal items such as a set of keys, a fob, or a badge to the second display screen coupling feature.

The NFT display system may be used to display an NFT and additional information on its display screen. The additional information may be information relevant to the user who is wearing the device or relevant to the area, event, situation to the NFT. For example and without limitation, a trade show may share an NFT to its attendees, a festival may share information to its concert goers, workers may receive information from their company, and so forth. The NFT display may be used to display digital art and/or information that would benefit being visibly worn such as art, logos to events, calendars or itinerary of an event, collectibles, identifications, or badge all in the name of an NFT or non-fungible token that is unique to an individual, event, trade show, concert, group of people, etc. with exclusive rights to the NFT.

The NFT display system may have the ability to create sound or music if the NFT includes sound or music.

The NFT display system may be used to display, house, store, trade, and collect NFT's in the device, from the device or to the device acting as a receiver, storage, and sender of NFT's.

### BRIEF DESCRIPTION OF THE DRAWINGS

Other features, combinations, and embodiments will be appreciated by one having the ordinary level of skill in the art of electronic display screen systems and accessories upon a thorough review of the following details and descriptions, particularly when reviewed in conjunction with the drawings, wherein:

FIG. 1 shows a front view of the NFT display system in accordance with a first illustrated embodiment;

FIG. 2 shows a front view of the NFT display system in accordance with a second illustrated embodiment;

FIG. 3 shows a front view of the NFT display system in accordance with a third illustrated embodiment;

FIG. 4 shows a front view of the NFT display system in accordance with a fourth illustrated embodiment;

FIG. 5 shows a front view of the NFT display system in accordance with a fifth illustrated embodiment;

FIG. 6 shows a partially transparent front view of the NFT display unit in accordance with a first illustrated embodiment;

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “coupling feature” refers to a feature or an assembly of features which may be removably coupled to another component.

The term “attached” refers to system of connecting two components which is not readily removable or detachable.

The term “integrated” refers to one or more distinct features which are nevertheless formed from the same continuous body or form.

Unless explicitly defined herein, terms are to be construed in accordance with the plain and ordinary meaning as would be appreciated by one having skill in the art.

### General Description of Embodiments

A variety of embodiments for a NFT display system are disclosed below. An NFT display system comprising a display unit and a wearable article allows a user to wear and display their chosen NFT collectible or NFT collectibles.

In some embodiments, the wearable article is a loop of fabric which forms a necklace, herein referred to as a lanyard. The lanyard may be worn around a user's neck. The lanyard may have a wearable article coupling feature such that the display unit may be coupled or attached to the wearable article coupling feature. In some embodiments, the wearable article coupling feature is formed from a sewn loop in the lanyard with a ring placed through the sewn loop. In some embodiments, the wearable article coupling feature may form a hook, clasp, clip magnet coupling, or other feature with a similar coupling functionality. In some embodiments, the wearable article may be worn other areas of a user's body besides around the neck.

The display unit is the structure or housing which holds the various electrical and mechanical components that power, control, and operate the display screen. In some embodiments, the display screen may be a kind of flat panel electrical display screen which emits light. For example, the display screen may be a liquid crystal display (LCD) screen, an organic light-emitting diode (OLED) screen, or an active-matrix organic light-emitting diode (AMOLED), a plasma display, or another type of electronic display screen which perform a similar electronic display functionality.

In some embodiments, the placement of the NFT digital collectible onto the display screen may be accomplished through wireless communication between the display unit electronics and the NFT source. The NFT source may be some form of a NFT cryptocurrency wallet. In some embodiments, the placement of the NFT onto the display screen may be accomplished through a wired connection between the display screen and the NFT source. In some embodiments, the placement of the NFT onto the display screen may be accomplished by inserting a memory storage device into a memory storage receiver disposed on the display unit. In some embodiments, the display unit electronics may store the NFT to be displayed within its hardware, firmware, software, memory storage device or some combination thereof In some embodiments, the user may place multiple NFTs on the display unit hardware, firmware, software, memory storage device or some combination thereof, such that the user may display multiple NFTs concurrently or in succession on the display screen.

The display unit may have a means of coupling the display unit to the wearable article. In some embodiments, the display unit may have a means of coupling other accessories, such as the user's personal items, to the display unit. In some embodiments, the top of the display unit may have a coupling feature, referred to as the first display unit coupling feature, disposed on the top end of the display unit. This first display unit coupling feature may itself be removably coupled, fixedly attached, or integrated with the display unit. The first display unit coupling feature may be capable of coupling, attaching, or otherwise engaging with a wearable article or a wearable article coupling feature.

In some embodiments, the display unit may have a second display unit coupling feature disposed on the bottom end of the display unit. This second display unit coupling feature may itself be removably coupled, fixedly attached, or integrated with the display unit. The second display unit coupling feature may be capable of coupling, attaching, or otherwise engaging with a given accessory or an accessory coupling feature. For example, the user may couple a set of keys, a fob, a badge, or a tether to the second display unit coupling feature. In some embodiments, the tether may be coupled to another accessory, such as a set of keys, a fob, a badge, so that when the tether is decoupled from the display unit the tether remains coupled to the accessory. For purposes herein, the tether is an accessory which itself may be coupled or attached to another accessory. The tether may have a first tether coupling feature which may be coupled to the second display screen coupling feature. The tether may have a second tether coupling feature which may be coupled with an accessory. In some embodiments, the display unit may have more than two coupling features such that additional accessories or wearable articles may be coupled to the display unit.

There are a variety of electrical sub-components which may be necessary or useful to the powering, controlling, and operating of the display unit and/or necessary to the receipt, storage, transmittal, or display of digital information on a display screen. These sub-components may exist in present-day devices. These sub-components may therefore be known or understandable to one of ordinary skill in the field of display screen devices.

The display unit may have a battery to supply electrical power to the display unit and display screen, providing energy for the various electrical functionalities of the display unit. The battery may be electrically connected to the display screen, the buttons, the indicator lights, and the charging port of the display unit. The charging port may receive a charging cable, or other charging power source, to recharge the energy level of the display unit battery. A charging port is a type of charge receiver. A charge receiver is a system which delivers charge to the battery. In some embodiments, the NFT display system may lack a charging port. The NFT display system may have another type of charge receiver, such as an electromagnetic induction charger. In some embodiments, the display unit may be capable of wireless charging in addition to, or instead of, charging via the charging port.

A plurality of control elements may be disposed on the exterior of the display unit, or disposed such that they are otherwise accessible to the user. These control elements may be any kind of toggle, switch, button, dial, slider, wheel, or other tactile actuatable element which performs similar functions. Among a wide range of possible functionalities, these control elements may allow the user to power on the display unit, power off the display unit, select a given NFT, select a display regiment of one or more NFTs (timing, order, display effects, etc.), NFT trading functionalities, or other user-controllable functionalities.

A plurality of indicator lights may be disposed on the exterior of the display unit, or disposed such that they are otherwise visible to the user. These indicator lights may illuminate in a variety of ways to indicate a variety of information to the user. Among a wide range of possible functionalities, these indicator lights may allow the device to indicate the power status of the display unit, the power level of the display unit battery, charge status of the battery, the selected NFT or NFTs to display, the display regiment of one or more NFTs (timing, order, display effects, etc.), activities related to trading, linking, storing, loading, receiving, sending, collecting information, and so forth.

In some embodiments, the need for indicator lights may be obviated or reduced. In such embodiments, the functionalities of the indicator lights described elsewhere in the specification may be accomplished by dedicating some area of the display screen, temporarily or permanently, to display the information which was in other embodiments communicated by the indicator lights.

In some embodiments, the display screen may be a touch screen. The touch screen display screen may receive and react to a tactile input from the user's skin. In some embodiments, of the touch screen display screen the need for buttons may be obviated or reduced. In such embodiments, the functionalities of the buttons described elsewhere in this specification may be accomplished by having the user interact with the touch screen display screen.

In some embodiments, the need for buttons and/or indicator lights may be obviated or reduced. In some embodiments, the functionalities of the buttons and/or indicator lights described elsewhere in the specification may be accomplished by wireless control of the display unit. One such possible method of wireless control of the display unit may be provide with Bluetooth connection to a user's personal device, such as a smart phone. The user may interface with their personal devices, and the display unit may receive the personal device inputs wirelessly. Similarly, the display unit may communicate settings, status, power levels, or other useful information back to the user's personal device wirelessly.

### Manufacturing

In some embodiments, the display screen can be obtained commercially. Alternatively, the display screen can be customized in accordance with the level and knowledge of one having skill in the art of electronic display screens.

In some embodiments, the wearable article, for example a lanyard, can be obtained commercially.

Generally, the lanyard is made of a textile material. Otherwise, the lanyard can be fabricated in accordance with the level and knowledge of one having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

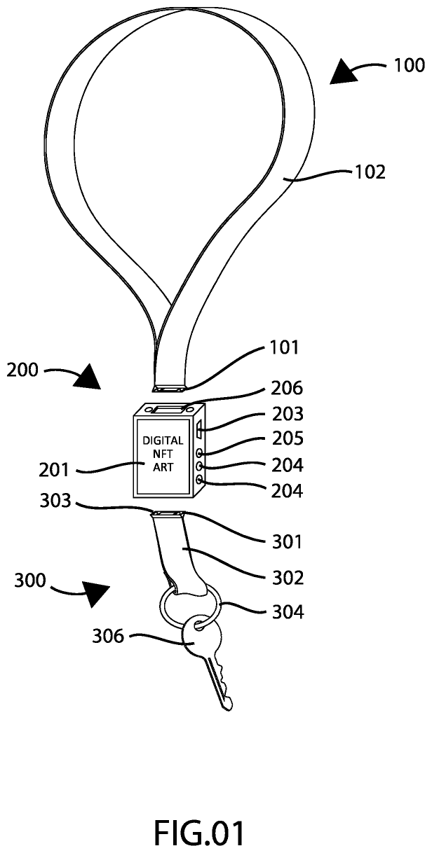

The first illustrated embodiment shown in FIG. 1 has a wearable article (100), a display unit (200), and an accessory (300). The wearable article has a wearable article coupling feature (101) which may be coupled to the first display unit coupling feature (206). The wearable article is a textile lanyard (102). The display screen (201) is disposed on the front of the display unit. The display unit of the first illustrated embodiment has a charge port (203), an indicator light (205), and two buttons (204) on its side face. Other embodiments may have a different number of indicator lights or buttons. Other embodiments may have indicator lights and buttons located in different places on the display unit.

The first illustrated embodiment shown in FIG. 1 also has an accessory (300) located below the display unit (200). The accessory has an accessory coupling feature (301) which may be coupled or attached to the display unit. The accessory in FIG. 1 is a tether (302). The second tether coupling feature (304) is attached to a set of keys (306).

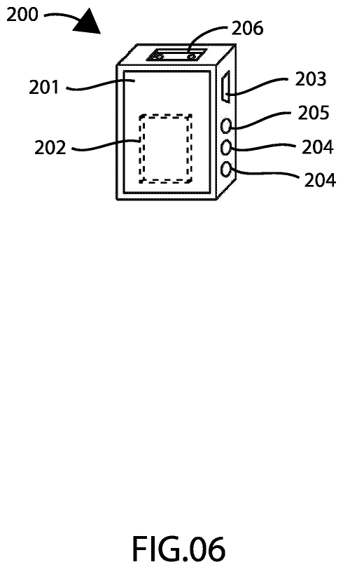

FIG. 6 shows a partially transparent view of a display unit of the first illustrated embodiment. The internal battery (202) of the display unit is shown in FIG. 6. The battery of other embodiments may be external or internal. The location of the battery may be different for different embodiments of the display unit.

### Second Illustrated Embodiment

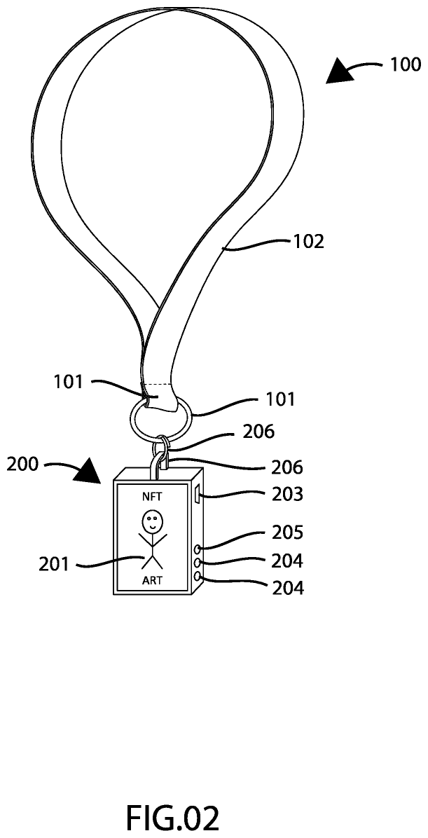

The second illustrated embodiments shown in FIG. 2 a wearable article (100) and a display unit (200). The wearable article has a wearable article coupling feature (101) which is coupled to the first display unit coupling feature (206) of the display unit. The user-selected NFT is shown on the display screen (201) which is disposed on the front face of the display unit.

### Third Illustrated Embodiment

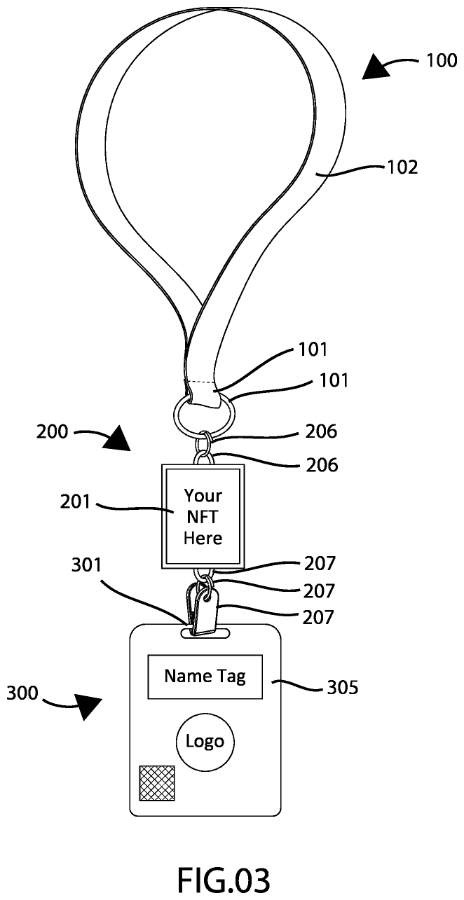

The third illustrated embodiment shown in FIG. 3 has a wearable article (100), a display unit (200), and an accessory (300). The accessory in the third embodiment is a badge (305). The display unit has a second display unit coupling feature (207) which is coupled to the accessory coupling feature (301) of the badge. The coupling feature of the badge is formed by a hole through the badge in the third illustrated embodiment.

### Fourth Illustrated Embodiment

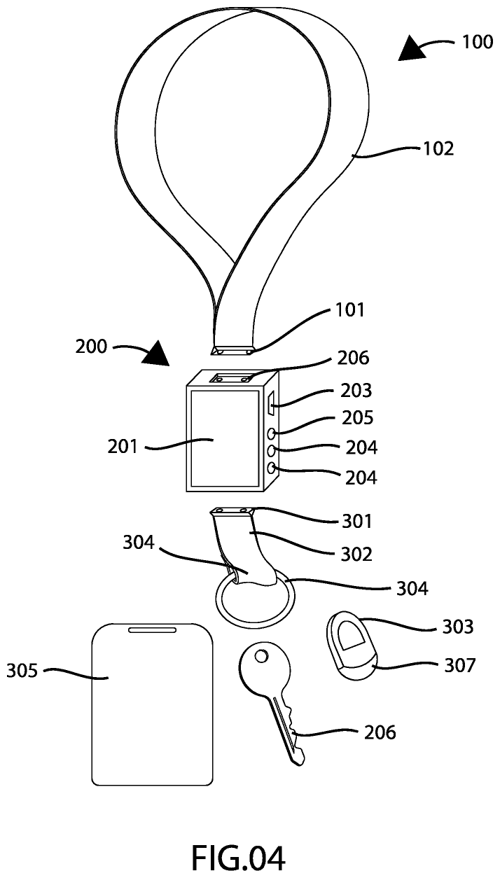

The fourth illustrated embodiment shown in FIG. 4 has a wearable article (100), a display unit (200), and multiple accessories (300). The first tether coupling feature (303) of the tether (302) may be coupled to the second display unit coupling feature (207), which is not shown in FIG. 4. The tether may be coupled to a variety of accessories such as a badge (305), a set of keys (306) or a fob (307), which are all shown in FIG. 4.

### Fifth Illustrated Embodiment

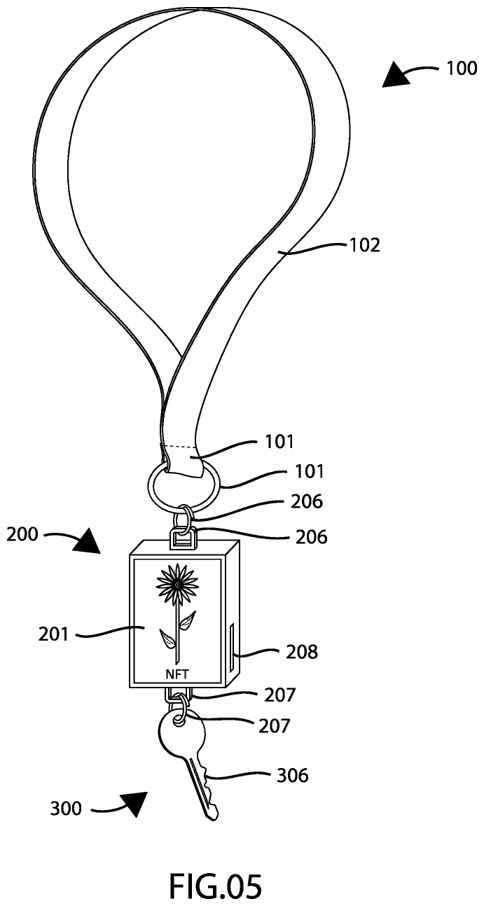

The fifth illustrated embodiment shown in FIG. 5 has a wearable article (100), a display unit (200), and an accessory (300). The display unit has a memory storage receiver (208) disposed on its side. Other embodiments do not require a memory storage receiver. The memory storage receiver may be in different locations on the display unit in different embodiments.

### FEATURE LIST

Wearable Article (100)
Wearable Article Coupling Feature (101)
Lanyard (102)
Display Unit (200)
Display Screen (201)
Battery (202)
Charge Port (203)
Button (204)
Indicator Light (205)
First Display Unit Coupling Feature (206)
Second Display Unit Coupling Feature (207)
Memory Storage Receiver (208)
Accessory (300)
Accessory Coupling Feature (301)
Tether (302)
First Tether Coupling Feature (303)
Second Tether Coupling Feature (304)
Badge (305)
Set of Keys (306)
Fob (307)

What is claimed is:

1. An NFT display system, comprising:
a. A electronic display unit; the display unit having a display screen, a battery, a charging port, an electronic control board (ECB) and circuitry, and a first display screen coupling feature; the battery being electrically connected to the electrical components of the display screen such that the battery may serve as an energy source, the battery being electrically connected to the charge port such that the battery may be recharged; the ECB and circuitry be connected to the display screen, battery, charge port such that the functions of these components may communicate information to and from the ECB and be controlled by the ECB.
b. A wearable article; the wearable article having a first wearable article coupling feature which can be coupled to the first display screen coupling feature.

2. The NFT display system of claim 1, further comprising:
a. A plurality of indicator lights; the indicator lights being disposed on the exterior of the display unit such that they are visible to the user, the indicator lights being electronically connected to the battery such that they may receive power from the battery, the indicator lights being electronically connected to the ECB and circuitry such that they may be controlled by the ECB.

3. The NFT display system of claim 1, further comprising:
a. A plurality of buttons; the buttons being disposed on the display unit such that they are accessible to the user, allowing the user to actuate the buttons, the buttons being electrically connected to the battery such that they may receive power from the battery, the buttons being electronically connected to the ECB and circuitry such that they may communicate information to and from the ECB and be controlled by the ECB.

4. The NFT display system of claim 1, further comprising:
a. A wireless charging receiver; the wireless charge receiver being capable of receiving electrical energy from an exterior wireless source and transmitting that energy to the battery to charge the battery, the wireless charging receiver being electrically connected to the battery such that it may deliver energy to the battery, the wireless charging receiver being electrically connected to the ECB and circuitry such that it may communicate information to and from the ECB and be controlled by the ECB.

5. The NFT display system of claim 1, further comprising:
a. A plurality of speakers; the speakers being electronically connected to the battery such that they may receive power from the battery, the speakers being electronically connected to the ECB and circuitry such that they may communicate information to and from the ECB and be controlled by the ECB.

6. The NFT display system of claim 1, further comprising:
a. A wireless control receiver; being electronically connected to the battery such that it may receive power from the battery, the wireless control receiver being electronically connected to the ECB and circuitry such that they may communicate information to and from the ECB and be controlled by the ECB.

7. The NFT display system of claim 1, further comprising:
a. A second display unit coupling feature, the second display unit coupling feature being a feature to which an accessory or personal item of the user may be coupled.

8. The NFT display system of claim 1, further comprising:
a. A wireless electromagnetic induction charger, the electromagnetic induction charger being electrically connected to the battery such that it may deliver energy to the battery, the electromagnetic induction charger being electrically connected to the ECB and circuitry such that it may communicate information to and from the ECB and be controlled by the ECB.
